(19) United States
(12) Patent Application Publication
(10) Pub. No.: US 2020/0387864 A1
(43) Pub. Date: Dec. 10, 2020

(54) COMPUTER-IMPLEMENTED SYSTEM AND METHOD FOR DETERMINING TOP ITEMS FOR A CUSTOM FULFILLMENT CENTER

(71) Applicant: COUPANG CORP., Seoul (KR)

(72) Inventor: Xin SHI, Seattle, WA (US)

(73) Assignee: Coupang Corporation

(21) Appl. No.: 16/431,556

(22) Filed: Jun. 4, 2019

(51) Int. Cl. G06Q 10/08; G06N 20/00

(52) U.S. Cl. CPC G06Q 10/0838; G06Q 30/0641; G06N 20/00

(57) ABSTRACT

The disclosed embodiments provide systems and methods for determining items for a custom fulfillment center. The system may include one or more memory devices storing instructions and one or more processors configured to execute the instructions to analyze, with a machine-learning algorithm, historical order data and geographic data, to determine one or more top items for a geographic area. Additionally, the system may provide data to a first user device for display to send the one or more top items to a vehicle with a custom fulfillment center and receive an order from a database, the order comprising one or more ordered items. Additionally, the system may and determine whether the ordered items include at least one top item and based on the determination, provide data to a second user device for display to fulfill the order at the custom fulfillment center.

### TECHNICAL FIELD

The present disclosure generally relates to computerized systems and methods for determining top items for a custom fulfillment center for fast shipping. In particular, embodiments of the present disclosure relate to inventive and unconventional systems which may analyze, with a machine-learning algorithm, historical order data and geographic data, to determine one or more top items for a geographic area, send top items to a vehicle with a custom fulfillment center, and quickly fulfill orders including top items.

### BACKGROUND

In current delivery systems, a user may place an order through a website on a user device, a system may determine the best place to fulfill the order within the targeted delivery time, and the order is fulfilled within the targeted delivery time.

Delivery speed is very important in the e-commerce industry. Present systems for one-day or same-day delivery in high density cities use urban fulfillment centers to serve small areas. Such a system may enable deliveries to take place within two hours of order time, which is very fast for current standards. However, this system is inefficient because it requires use of a static fulfillment center or warehouse in an urban area, which tends to be expensive and is not fulfilling orders fast enough. Current computerized systems only account for the static placement of goods at these fulfillment centers and do not account for super-popular goods. Known electronic systems for accomplishing e-commerce logistics rely upon that paradigm in that they rely on goods being stored at central locations.

In view of the shortcomings of current electronic systems and methods for fast shipping, a system for enhancing the shipping, transportation, and logistics operation of shipping orders using systems and methods for determining top items for a custom fulfillment center—analyzing, with a machine-learning algorithm, historical order data and geographic data, to determine one or more top items for a geographic area and sending top items to a custom fulfillment center on a vehicle—is desired. More specifically, a computer-implemented system and method for determining items for a custom fulfillment center is desired to provide efficiency by fulfilling orders faster, for example, within 30 minutes. Such a system would efficiently group top items on a custom fulfillment center on a vehicle in a high-density city, getting more orders through the system faster, taking in more orders, and cutting down wasted time. Therefore, there is a need for improved electronic methods and systems for fast shipping using a custom fulfillment center.

### SUMMARY

One aspect of the present disclosure is directed to a computer-implemented system for determining items for a custom fulfillment center. For example, certain embodiments may include one or more memory devices storing instructions and one or more processors configured to execute the instructions. In some embodiments, the one or more processors are configured to execute the instructions to analyze, with a machine-learning algorithm, historical order data and geographic data, to determine one or more top items for a geographic area and provide data to a first user device for display to send the one or more top items to a vehicle with a custom fulfillment center. Additionally, the one or more processors are configured to receive an order from a database, the order comprising one or more ordered items and determine whether the ordered items include at least one top item. Additionally, the one or more processors are configured to, based on the determination, provide data to a second user device for display to fulfill the order at the custom fulfillment center and change order data associated with the order to signify that the order will be fulfilled by the custom fulfillment center.

Another aspect of the present disclosure is directed to a computer-implemented system for determining items for a custom fulfillment center. For example, certain embodiments may include one or more memory devices storing instructions and one or more processors configured to execute the instructions. In some embodiments, the one or more processors are configured to execute the instructions to analyze, with a machine-learning algorithm, historical order data and geographic data, to determine one or more top items for a geographic area and provide data to a first user device for display to send the one or more top items to a vehicle with a custom fulfillment center in a neighborhood zone. In some embodiments, the one or more processors are configured to receive an order from a database, the order comprising one or more ordered items and determine whether the ordered items include at least one top item. Additionally, the one or more processors are configured to, based on the determination, provide data to multiple user devices in the neighborhood zone for display to fulfill the order at the custom fulfillment center, receive confirmation from one of the multiple user devices in the neighborhood zone for fulfilling the order at the custom fulfillment center, and change order data associated with the order to signify that the order will be fulfilled by the custom fulfillment center.

Yet another aspect of the present disclosure is directed to a computer-implemented method for determining items for a custom fulfillment center. For example, certain embodiments may include analyzing, with a machine-learning algorithm, historical order data and geographic data, to determine one or more top items for a geographic area and provide data to a first user device for display to send the one or more top items to a vehicle with a custom fulfillment center in a neighborhood zone. In some embodiments, method further includes receiving an order from a database, the order comprising one or more ordered items and determining whether the ordered items include at least one top item. Additionally, the method includes, based on the determination, providing data to multiple user devices in the neighborhood zone for display to fulfill the order at the custom fulfillment center, receiving confirmation from one of the multiple user devices in the neighborhood zone for fulfilling the order at the custom fulfillment center, and changing order data associated with the order to signify that the order will be fulfilled by the custom fulfillment center.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a diagrammatic illustration of an exemplary process including determining items for a custom fulfillment center and order fulfillment, consistent with the disclosed embodiments.

FIG. 4 is a block diagram of an exemplary process for determining items for a custom fulfillment center, consistent with disclosed embodiments.

FIG. 5 is a block diagram of logic of an exemplary machine-learning algorithm, consistent with disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to a computer-implemented system for determining items for a custom fulfillment center. For example, certain embodiments may include one or more memory devices storing instructions and one or more processors configured to execute the instructions. In some embodiments, the one or more processors are configured to execute the instructions to analyze, with a machine-learning algorithm, historical order data and geographic data, to determine one or more top items for a geographic area and provide data to a first user device for display to send the one or more top items to a vehicle with a custom fulfillment center. Additionally, the one or more processors are configured to receive an order from a database, the order comprising one or more ordered items and determine whether the ordered items include at least one top item. Additionally, the one or more processors are configured to, based on the determination, provide data to a second user device for display to fulfill the order at the custom fulfillment center and change order data associated with the order to signify that the order will be fulfilled by the custom fulfillment center.

The present system allows for efficiency through analyzing, with a machine-learning algorithm, historical order data, and geographic data, to determine one or more top items for a geographic area, moving top items to the custom fulfillment center, getting more orders through the system faster, taking in more orders, and cutting down wasted time. In some embodiments, the system efficiently groups top-selling or top-searched-for items on a custom fulfillment center on a vehicle in a high-density area and may deliver these items within thirty minutes of order time. As described below, building shipping systems on a vehicle or moving truck may allow for more flexible and fast delivery.

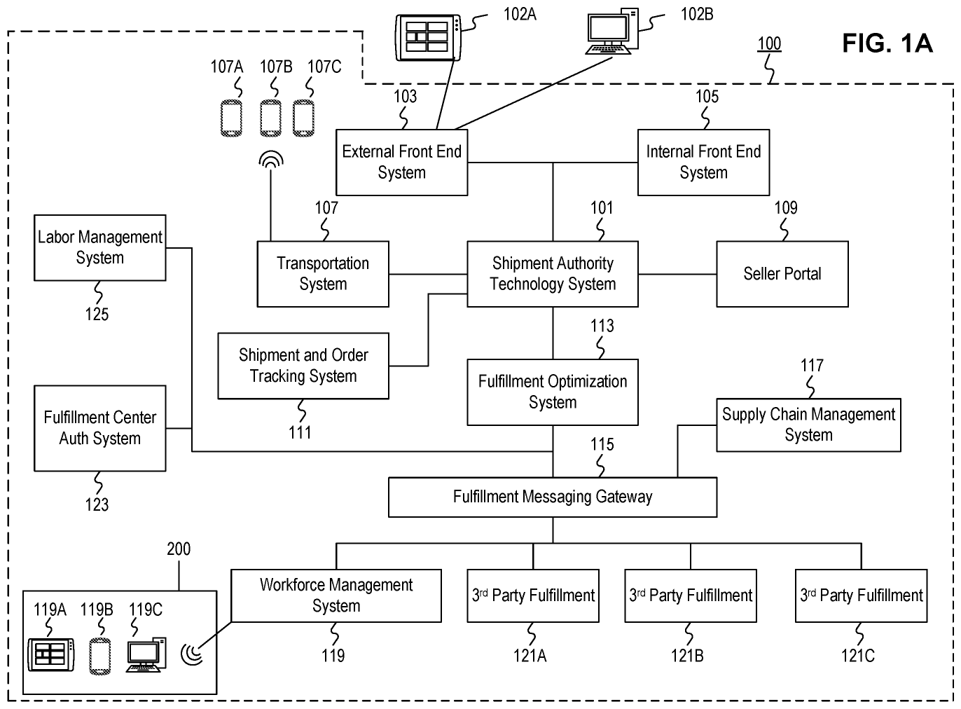

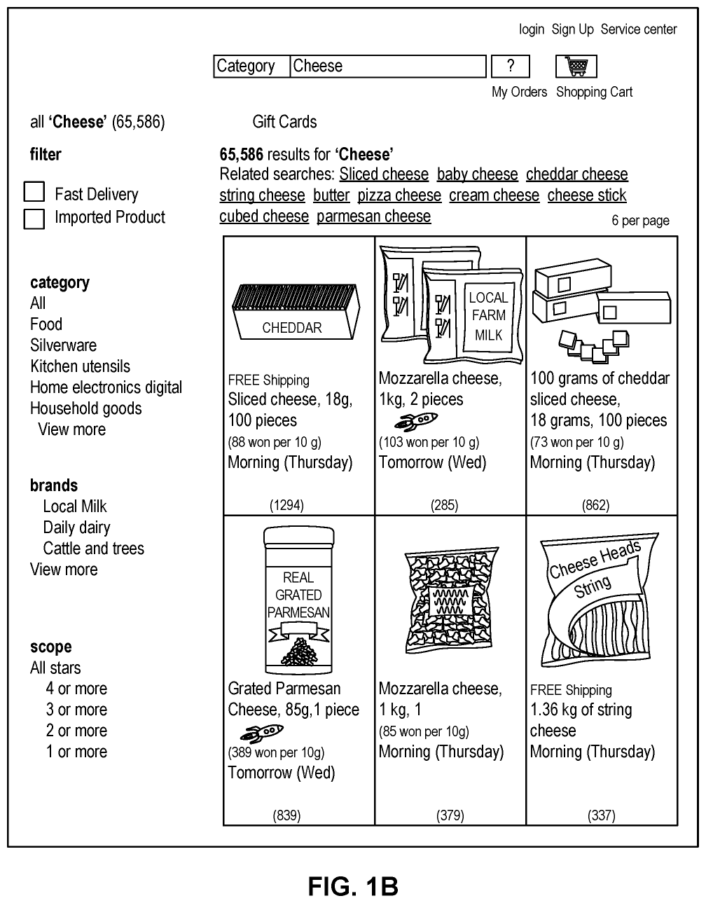

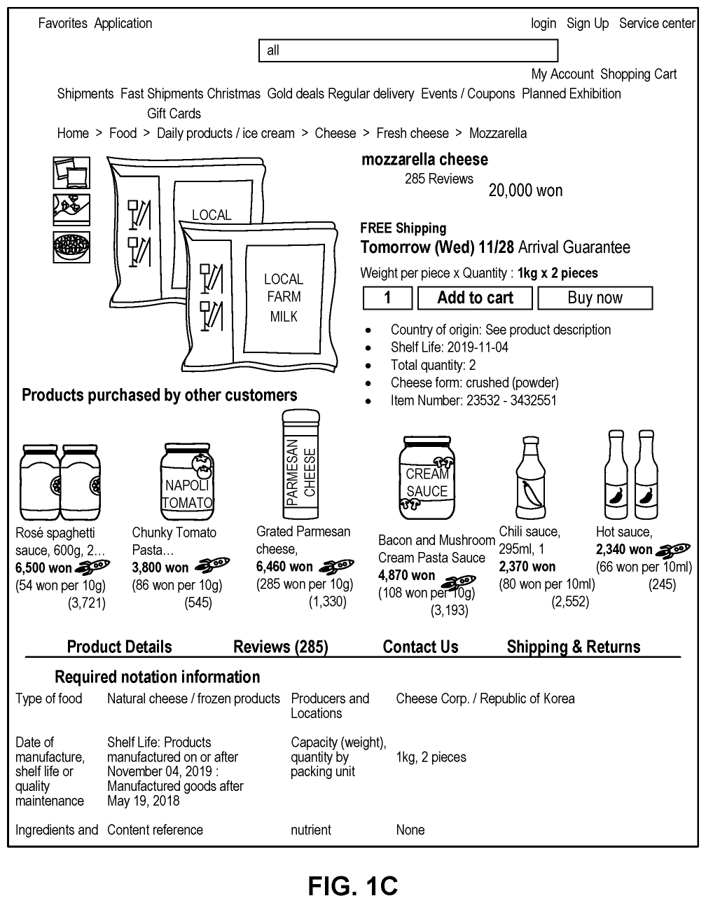

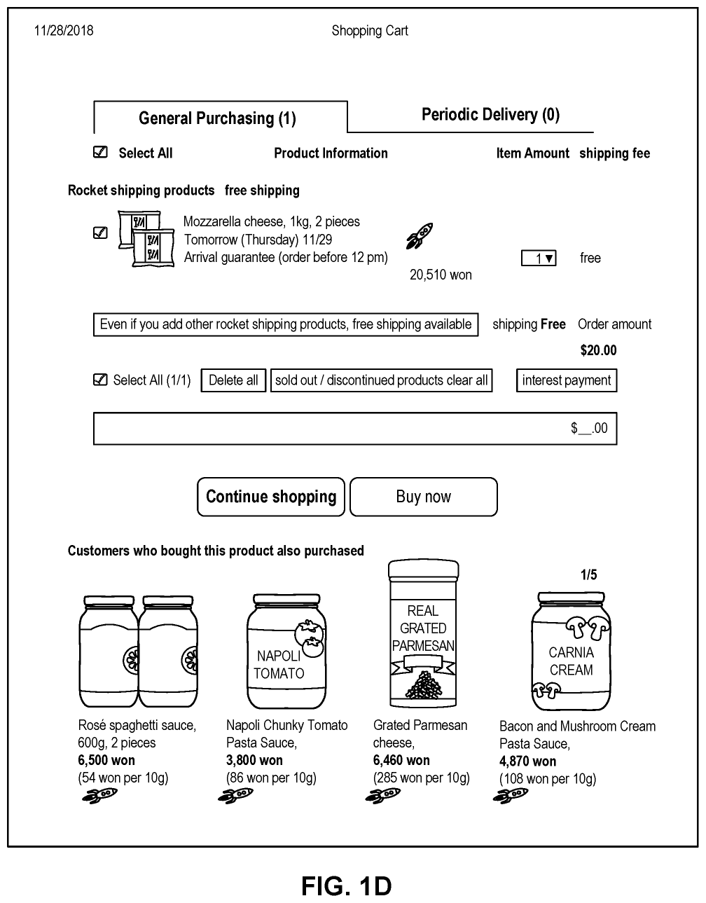

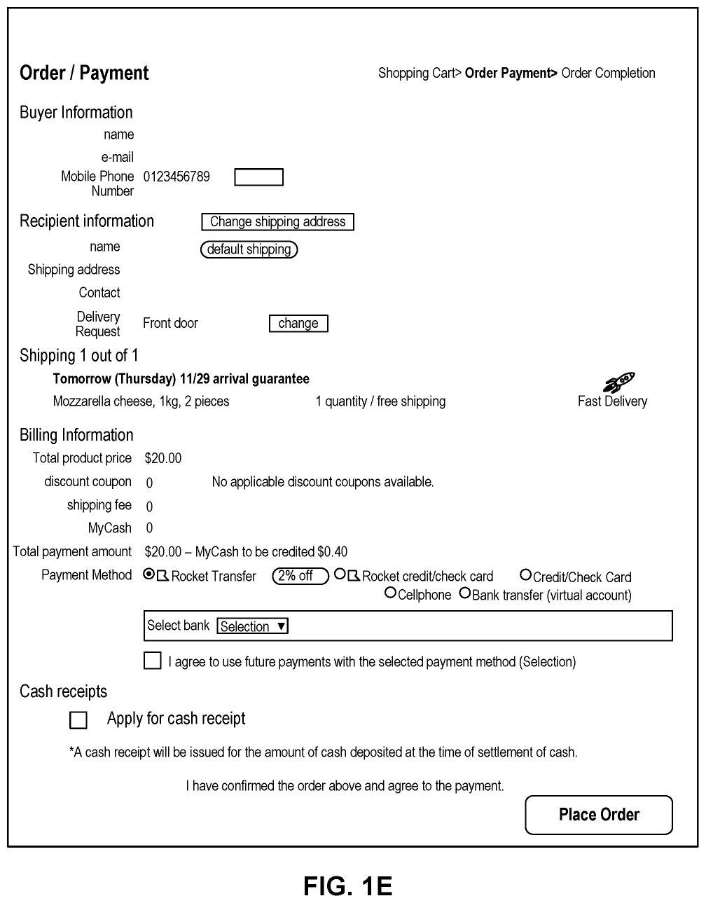

Referring to FIG. 1A, a schematic block diagram illustrating an exemplary embodiment of a system 100 comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 1078, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 1198, and 119C (depicted as being inside of fulfillment center (FC) 200), 3rd party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, may help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product may arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfillment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfillment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3rd party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

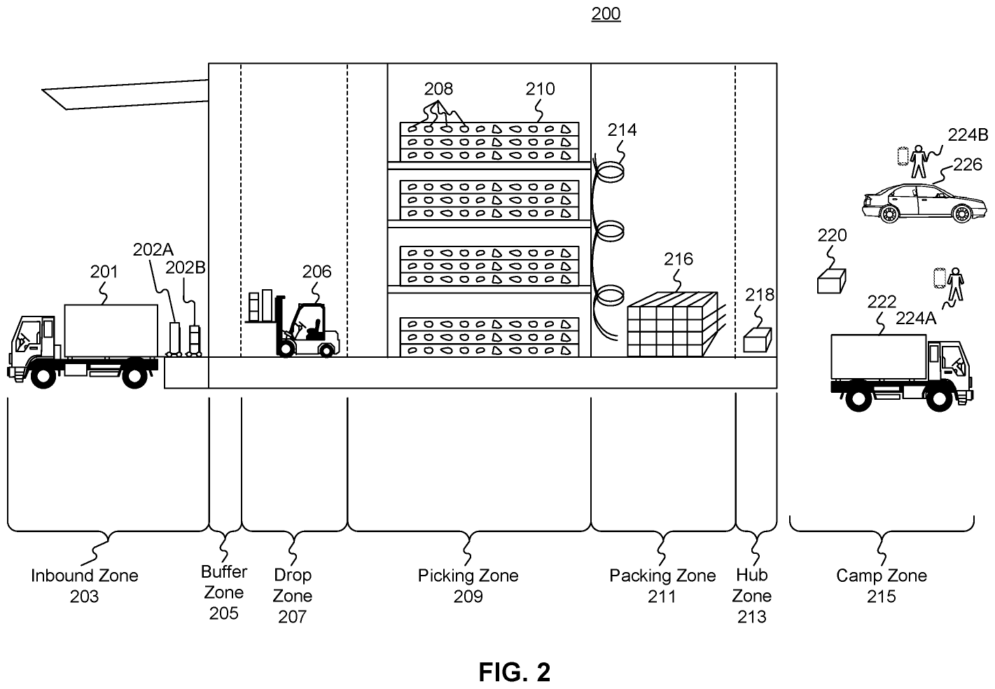

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, may use it during the day, and may return it at the end of the day).

WMS 119, in some embodiments, may maintain a work log for each user associated with system 100. For example, WMS 119 may store information associated with each employee, including any assigned processes (e.g., unloading trucks, picking items from a pick zone, sorting apparatus work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker may receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) may receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages may go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

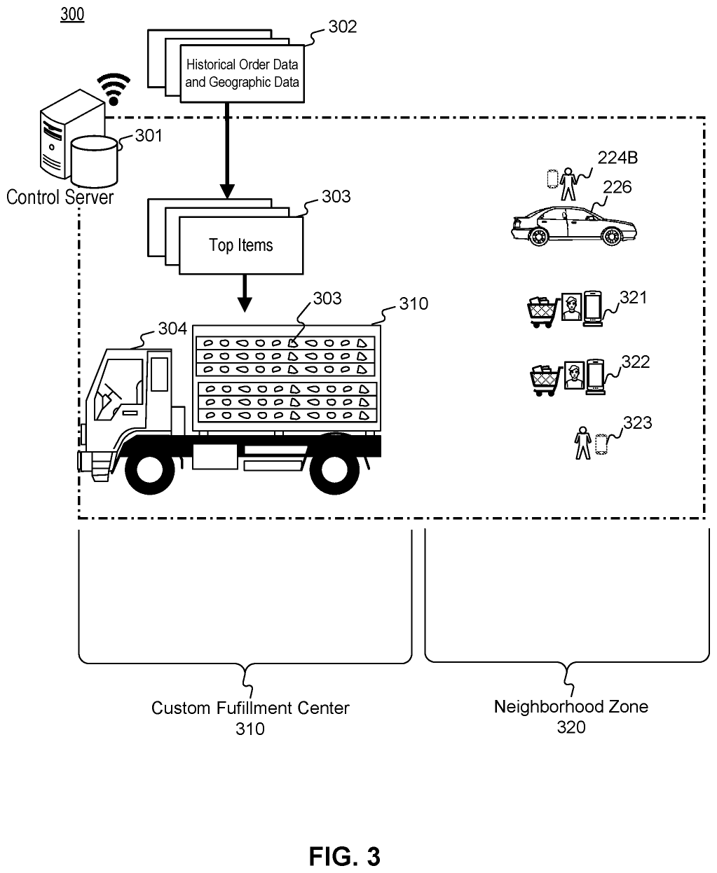

FIG. 3 is a diagrammatic illustration of an exemplary process 300 including determining items for a custom fulfillment center and order fulfillment, consistent with the disclosed embodiments.

In prior art methods, computer implemented processes for providing fast delivery consisted of one-day or same-day delivery which utilized urban fulfillment centers in high density cities to serve small areas. Such systems provided instructions to enable deliveries within two hours of order time, which was very fast for prior standards. However, this system is inefficient because it requires use of a static fulfillment center or warehouses in urban areas, which are expensive. Moreover, the static fulfillment center cannot utilize computer implemented processes to move the fulfillment center order to fulfill orders faster. As delivery speed continues to be extremely important in the e-commerce industry, a method that analyzes historical order data and geographic data and provides instructions to deliver orders within thirty minutes is far more advantageous than the current systems that deliver orders within two hours.

The present system allows for efficiency through analyzing, with a machine-learning algorithm, historical order data, and geographic data, to determine one or more top items for a geographic area, moving top items to the custom fulfillment center, getting more orders through the system faster, taking in more orders, and cutting down wasted time. In some embodiments, the system efficiently groups top-selling or top-searched-for items on a custom fulfillment center on a vehicle in a high-density area and may deliver these items within thirty minutes of order time. As described below, building shipping systems on a vehicle or moving truck may allow for more flexible and fast delivery.

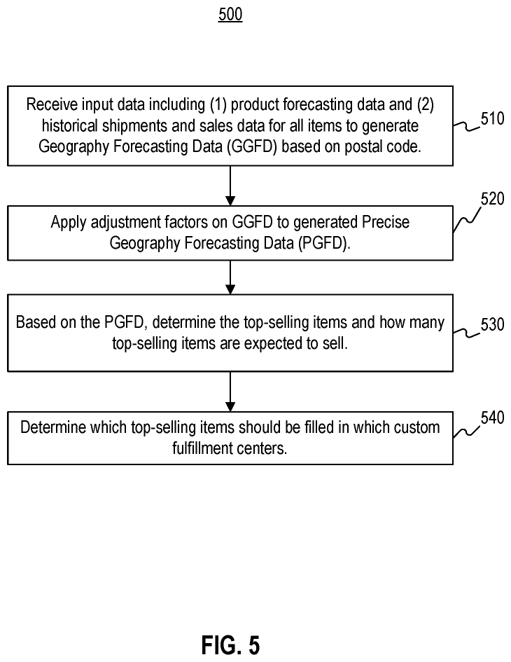

In some embodiments, the machine-learning algorithm, as described below with respect to FIG. 5, may produce forecasting data for each item. The forecasting data may be used as an input to determine which items should be placed in the custom fulfillment center. In some embodiments, the machine learning algorithm comprises four steps:

Step 1: Receive input data including (1) nation wide product forecasting data (produced by forecasting team or by machine-learning algorithm) and (2) historical shipments and sales data for all items. Using the two types of input data, the machine-learning algorithm may generate Item General Geography Forecasting Data (GGFD) based on postal code. GGFD includes, for example, data regarding (1) nationwide product forecasting data and (2) historical shipments and sales data for items to create data relating to expected sales for each item in a specific area (e.g., a postal code).

Step 2: Apply adjustment factors on GGFD to generated Precise Geography Forecasting Data (PGFD). In some embodiments, PGFD includes data relating to expected sales for each item in a specific area (e.g., a postal code). The adjustment factors may include a seasonality factor. For example, based on a given month's or quarter's data, the machine-learning algorithm may adjust GGFD. The adjustment factors may also include a popularity or search factor. For example, the machine-learning algorithm may adjust GGFD based on varying search data (or social media data). In some embodiments, the popularity factor may have a heavier weight than the seasonality factor for determining PGFD. In some embodiments, the popularity factor may weigh twice as much as the seasonality factor in adjusting GGFD.

Step 3: Based on the PGFD for each item, the machine-learning algorithm determines the top-selling items and how many top-selling items are expected to sell.

Step 4: Because the capacity of custom fulfillment center (e.g. a vehicle or moving truck) is limited, the machine-learning algorithm determines how to utilize the capacity by using linear programming. The machine-learning algorithm also uses linear programming to determine which top-selling items should be filled in which custom fulfillment centers. This can be based on maximizing certain outputs, like sales amount, sales unit, or contribution profit. For example, in some embodiments, the machine-learning algorithm may instruct SAT system 101 to fill a custom fulfillment center with a certain item in order to increase sales in a sales unit.

For example, in some embodiments, a vehicle may be located in a high-density area (e.g., a city, county, or other political or geographical subdivision) and may include a custom fulfillment center storing products that sell well in that area (top items). As described above, the delivery workers, who may be permanent, temporary, or shift employees, may utilize mobile devices 107A-107C of FIG. 1A to complete delivery of packages containing the products (top items) ordered by users. In some embodiments, SAT system 101 may leverage neighborhood resources, such as delivery workers in the neighborhood or neighborhood zone 320, for the delivery. For example, delivery workers may be located in varying neighborhoods of a high-density city in order deliver ordered items faster.

Some embodiments implement the disclosed methods and systems in high-density areas, while in other embodiments the disclosed methods and systems may be employed in other areas. For example, in some embodiments, custom fulfillment center 310 filled with top items 303 may be utilized in and located in a less populated area (e.g., a countryside location) in order to defray the cost of shipping a relatively small number of items to that location when the items are ordered.

Process 300 depicts control server 301 for connections between one or more of the systems of FIG. 1A. In some embodiments of process 300, SAT system 101 may analyze historical order data and geographic data 302 in order to determine top items 303 for a geographic area or neighborhood zone 320. SAT system 101 may analyze historical order data and geographic data 302 using a machine-learning algorithm. Historical order data may be based at least on search data from users and search data from past orders. Geographic data may be based at least on postal code. In response to the determination of top items 303 for a geographic area, SAT system 101 may provide data to a first user device (PDA, a smart phone, a tablet, a laptop, or other computer device) to send top items 303 to vehicle 304 with a custom fulfillment center 310. In some embodiments, the determination of top items 303 for a geographic area may be made before the items are popular in that area. In such an embodiment, custom fulfillment center 310 may be stocked with top items 303 in advance of items being frequently ordered in that area. For example, a football game between two rivals may be occurring in a city in two weeks. SAT system 101 may determine that one week from today, top items 303 for that city will include apparel of the local football team. Accordingly, SAT system 101 may provide data to a user device to send top items 303 (sports apparel) to vehicle 304 with a custom fulfillment center 310 located in that city, in advance of the surge in orders of top item 303.

In some embodiments, vehicle 304 may be loaded with top items 303 at camp zone 215 of FIG. 2. In other embodiments, delivery workers may pick up top items 303 from camp zone 215 of FIG. 2 and load vehicle 304 with top items 303 at any location in the high-density city.

An illustrative example of three neighborhoods follows. A first neighborhood may be a young professional neighborhood of a high-density city. In the first neighborhood, top items 303 may include smart speakers, athletic equipment, and TVs. A second neighborhood may be located near a residential area of a high-density city. In the second neighborhood, for example, top items 303 may include baby bibs, baby toys, and cleaning products. A third neighborhood may be located near a college or university in a city. In the third neighborhood, for example, top items 303 may include textbooks, highlighters, and sticky notes. Each neighborhood or neighborhood zone 320 may include a unique vehicle 304 with a unique fulfillment center 310 holding top items 303 for that neighborhood or neighborhood zone 320.

In some embodiments, items of each order may have been placed by users at devices such as mobile device 102A or computer 102B of FIG. 1A through a website hosted on external front end system 103 of FIG. 1A. In some embodiments, mobile device 102A or computer 102B of FIG. 1A may send order information (comprising one or more desired items) through a website hosted on external front end system 103 of FIG. 1A (e.g., as described above with regard to FIGS. 1B-1E).

In response to an order being placed, SAT system 101 may receive the order from a database. In some embodiments, the order may include multiple items. SAT system 101 may determine whether ordered items include at least one top item 303. If SAT system 101 determines that top item 303 was ordered, SAT system 101 may provide data to a user device of a delivery worker, either on vehicle 304 or separate from vehicle 304, to fulfill the order by picking up the ordered top item at custom fulfillment center 310. If SAT system 101 determines that the order is not completely fulfillable by the fulfillment center 310, SAT system 101 may split up items in the order by making a new order. In other embodiments, SAT system 101 may limit the total orderable inventory for the items in the customized warehouse due to the capacity limitation of custom fulfillment center 310 such as a vehicle (e.g. if custom fulfillment center 310 carries 10 units of item A, SAT system 101 may only allow the sale of 10 units for item A in that area). Furthermore, in some embodiments, when the user views the item online, SAT system 101 may receive the user's location and/or shipment address data in order to determine which custom fulfillment center may handle the request.

In some embodiments, vehicle 304 may be stationary and used as a trailer. In such an embodiment, SAT system 101 may notify delivery workers 224B, 321, 322, and 323 to fulfill the order for delivery. For example, delivery worker 323 may walk the ordered top item for delivery to the shipping address. Delivery workers 321 and 322 may bike or scooter the ordered top item for delivery. Delivery worker 224B may drive the ordered top item for delivery using car 226. SAT system 101 may notify delivery workers 224B, 321, 322, 323, and others based on their proximity to custom fulfillment center 310, proximity to neighborhood zone 320, their mode of transportation, and distance from custom fulfillment center 310 to shipping address.

In one example, SAT system 101 may notify four delivery workers that may deliver the ordered top item at a similar time because they are in neighborhood zone 320 or equidistant from neighborhood zone 320. Once a first delivery worker provides a confirmation indication that he/she will deliver the ordered top item, SAT system 101 may provide a notification to the remaining three delivery workers that another delivery worker in neighborhood zone 320 is fulfilling the order.

In other embodiments, vehicle 304 may be dynamic and moving through the neighborhood in order to fulfill more orders and fulfill orders faster. A delivery worker on vehicle 304 may receive data on user device to fulfill an order at the custom fulfillment center and drive vehicle 304 to the shipping address to fulfill the order. In such an embodiment where vehicle 304 is moving, delivery workers 224B, 321, 322, and 323 may still fulfill orders from custom fulfillment center 310. For example, vehicle 304 may drive up and down a busy street and delivery workers 224B, 321, 322, and 323 may approach vehicle 304 to stop on its route.

In some embodiments, delivery workers may use automated scanning equipment (e.g., associated with computer 119C) to scan a barcode associated with the SKUs for storing information regarding the order parts. In yet other embodiments, the SKUs allow a worker (as described above in FIG. 2) to read the order parts for delivery.

Once the ordered top item is picked up at custom fulfillment center 310, SAT system 101 may change order data associated with the order to signify that the order will be fulfilled by the custom fulfillment center.

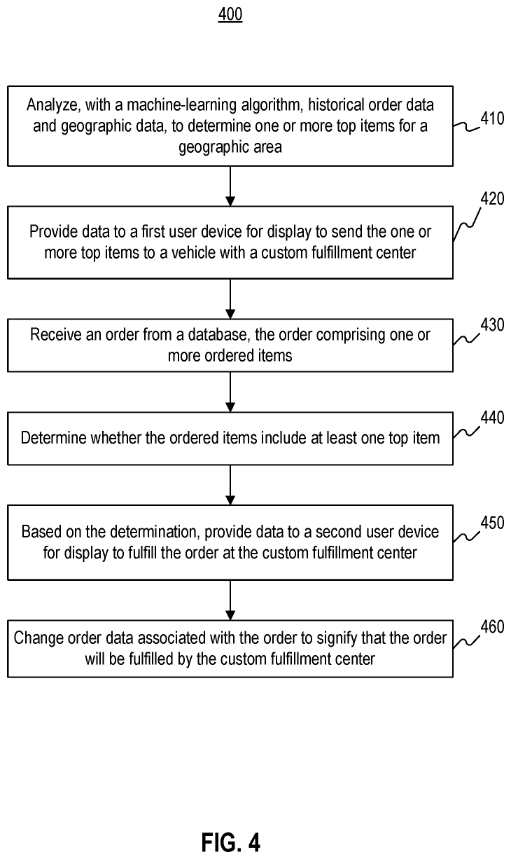

FIG. 4 is a block diagram of an exemplary process for batch optimization. Process 400 may be performed by processor of, for example, SAT system 101, which executes instructions encoded on a computer-readable medium storage device. It is to be understood, however, that one or more steps of process 400 may be implemented by other components of system 100 (shown or not shown).

At step 410, system 100 may analyze, with a machine-learning algorithm, historical order data and geographic data, to determine one or more top items for a geographic area. Historical order data may be based at least on search data and previous order data. In some embodiments, items of previous orders may have been placed by users at devices mobile device 102A or computer 102B of FIG. 1A through a website hosted on external front end system 103 of FIG. 1A. Geographic data may be based at least on postal code.

At step 420, system 100 may provide data to a first user device (PDA, a smart phone, a tablet, a laptop, or other computer device) to send top items 303 to vehicle 304 with a custom fulfillment center 310. In some embodiments, vehicle 304 may be loaded with top items 303 at camp zone 215 of FIG. 2. In other embodiments, delivery workers may pick up top items 303 from camp zone 215 of FIG. 2 and load vehicle 304 with top items 303 at any location in the high-density city. Furthermore, in some embodiments, when SAT system 101 determines to fulfill an order from a custom fulfillment center, SAT system 101 modifies order data and other data to indicate that the order should be fulfilled from such a center.

At step 430, SAT system 101 may receive an order from a database, the order comprising one or more ordered items. In some embodiments, items of each order may have been placed by users at devices such as mobile device 102A or computer 102B of FIG. 1A through a website hosted on external front end system 103 of FIG. 1A. In some embodiments, mobile device 102A or computer 102B of FIG. 1A may send order information (comprising one or more desired items) through a website hosted on external front end system 103 of FIG. 1A (e.g., as described above with regard to FIGS. 1B-1E).

At step 440, SAT system 101 may determine whether the ordered items include at least one top item by checking a database with incoming orders.

At step 450, SAT system 101 may, based on the determination, provide data to a second user device for display to fulfill the order at the custom fulfillment center. If SAT system 101 determines that top item 303 was ordered, SAT system 101 may provide data to a user device of delivery worker 224B, 321, 322, or 323, either on vehicle 304 or separate from vehicle 304, to fulfill the order by picking up the ordered top item at custom fulfillment center 310.

At step 460, SAT system 101 may change order data associated with the order to signify that the order will be fulfilled by the custom fulfillment center.

FIG. 5 is a block diagram of logic of an exemplary machine-learning algorithm process 500, consistent with disclosed embodiments.

In some embodiments, the machine-learning algorithm may produce forecasting data for each item. The forecasting data may be used as an input to determine which items should be placed in the custom fulfillment center. In some embodiments, the machine learning algorithm comprises four steps:

Step 510: Receive input data including (1) nationwide product forecasting data (produced by forecasting team or by machine-learning algorithm) and (2) historical shipments and sales data for all items. Using the two types of input data, the machine-learning algorithm may generate Item General Geography Forecasting Data (GGFD) based on postal code. GGFD includes, for example, data regarding (1) nationwide product forecasting data and (2) historical shipments and sales data for items to create data relating to expected sales for each item in a specific area (e.g., a postal code).

Step 520: Apply adjustment factors on GGFD to generated Precise Geography Forecasting Data (PGFD). In some embodiments, PGFD includes data relating to expected sales for each item in a specific area (e.g., a postal code). The adjustment factors may include a seasonality factor. For example, based on a given month's or quarter's data, the machine-learning algorithm may adjust GGFD. The adjustment factors may also include a popularity or search factor. For example, the machine-learning algorithm may adjust GGFD based on varying search data (or social media data). In some embodiments, the popularity factor may have a heavier weight than the seasonality factor for determining PGFD. In some embodiments, the popularity factor may weigh twice as much as the seasonality factor in adjusting GGFD.

Step 530: Based on the PGFD for each item, the machine-learning algorithm determines the top-selling items and how many top-selling items are expected to sell.

Step 540: Because the capacity of custom fulfillment center (e.g. a vehicle or moving truck) is limited, the machine-learning algorithm determines how to utilize the capacity by using linear programming. The machine-learning algorithm also uses linear programming to determine which top-selling items should be filled in which custom fulfillment centers. This can be based on maximizing certain outputs, like sales amount, sales unit, or contribution profit. For example, in some embodiments, the machine-learning algorithm may instruct SAT system 101 to fill a custom fulfillment center with a certain item in order to increase sales in a sales unit.

While the present disclosure has been shown and described with reference to particular embodiments thereof, it may be understood that the present disclosure may be practiced, without modification, in other environments. The foregoing description has been presented for purposes of illustration. It is not exhaustive and is not limited to the precise forms or embodiments disclosed. Modifications and adaptations may be apparent to those skilled in the art from consideration of the specification and practice of the disclosed embodiments. Additionally, although aspects of the disclosed embodiments are described as being stored in memory, one skilled in the art may appreciate that these aspects may also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules may be created using any of the techniques known to one skilled in the art or may be designed in connection with existing software. For example, program sections or program modules may be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A system for determining items for a custom fulfillment center, the system comprising:
one or more memory devices storing instructions; and
one or more processors configured to execute the instructions to:
analyze, with a machine-learning algorithm, historical order data and geographic data, to determine one or more top items for a geographic area;
apply an adjustment factor based on search data, by the machine-learning algorithm, to the one or more top items for the geographic area;
determine, with the machine-learning algorithm and linear programming, how to utilize a capacity of a vehicle with a custom fulfillment center;
based on the determination by the machine-learning algorithm, provide data to a first user device for display to send the one or more top items adjusted by the adjustment factor to the vehicle with the custom fulfillment center;
receive an order from a database, the order comprising one or more ordered items;
determine whether the ordered items include at least one top item;
based on the determination whether the ordered items include the at least one top item, provide data to a user via a second user device for display to fulfill the order at the custom fulfillment center and instruct the user via the second user device for display to deliver the order; and
change order data associated with the order to signify that the order will be fulfilled by the custom fulfillment center.

2. The system of claim 1, wherein the vehicle with a custom fulfillment center is a static trailer.

3. The system of claim 1, wherein the vehicle with a custom fulfillment center is a moving truck.

4. The system of claim 1, wherein the second user device is determined based on proximity to the custom fulfillment center.

5. The system of claim 1, wherein the first user device is one of a PDA, a smart phone, a tablet, a laptop, or other computer device.

6. The system of claim 1, wherein the second user device is one of a PDA, a smart phone, a tablet, a laptop, or other computer device.

7. The system of claim 1, wherein historical order data is updated every twenty-four hours.

8. The system of claim 1, wherein geographic data is based at least on a postal code.

9. The system of claim 1, wherein historical order data is based at least on search data.

10. A system for determining items for a custom fulfillment center, the system comprising:
one or more memory devices storing instructions; and
one or more processors configured to execute the instructions to:
analyze, with a machine-learning algorithm, historical order data and geographic data, to determine one or more top items for a geographic area;
apply an adjustment factor based on search data, by the machine-learning algorithm, to the one or more top items for the geographic area
determine, with the machine-learning algorithm and linear programming, how to utilize a capacity of a vehicle with a custom fulfillment center;
based on the determination by the machine-learning algorithm, provide data to a first user device for display to send the one or more top items adjusted by the adjustment factor to the vehicle with the custom fulfillment center in a neighborhood zone, wherein the geographic area includes one or more neighborhood zones;
receive an order from a database, the order comprising one or more ordered items;
determine whether the ordered items include at least one top item;
based on the determination whether the ordered items include the at least one top item, provide data to multiple users via multiple user devices in the neighborhood zone for display to fulfill the order at the custom fulfillment center;
receive confirmation from a user of one of the multiple user devices in the neighborhood zone for fulfilling the order at the custom fulfillment center; instruct the user via one of the multiple user devices to deliver the order; and
change order data associated with the order to signify that the order will be fulfilled by the custom fulfillment center.

11. The system of claim 10, wherein the vehicle with a custom fulfillment center is a static trailer.

12. The system of claim 10, wherein the vehicle with a custom fulfillment center is a moving truck.

13. The system of claim 10, wherein the multiple user devices in the neighborhood zone are determined based on proximity to the custom fulfillment center.

14. The system of claim 10, wherein the first user device is one of a PDA, a smart phone, a tablet, a laptop, or other computer device.

15. The system of claim 10, wherein the multiple user devices are one of a PDA, a smart phone, a tablet, a laptop, or other computer device.

16. The system of claim 10, further comprising: provide data to the remaining multiple user devices in the neighborhood zone that one of the multiple user devices in the neighborhood zone is fulfilling the order.

17. The system of claim 10, wherein historical order data is updated every twenty-four hours.

18. The system of claim 10, wherein geographic data is based at least on a postal code.

19. The system of claim 10, wherein historical order data is based at least on search data.

20. A computer-implemented method for determining items for a custom fulfillment center, the system comprising:
analyzing, with a machine-learning algorithm, historical order data and geographic data, to determine one or more top items for a geographic area;
applying an adjustment factor based on search data, by the machine-learning algorithm, to the one or more top items for the geographic area;
determining, with the machine-learning algorithm and linear programming, how to utilize a capacity of a vehicle with a custom fulfillment center;
based on the determination by the machine-learning algorithm, providing data to a first user device for display to send the one or more top items adjusted by the adjustment factor to the vehicle with the custom fulfillment center in a neighborhood zone, wherein
the geographic area includes one or more neighborhood zones;
receive an order from a database, the order comprising one or more ordered items;
determining whether the ordered items include at least one top item;
based on the determination whether the ordered items include the at least one top item, providing data to multiple user devices in the neighborhood zone for display to fulfill the order at the custom fulfillment center;
receiving confirmation from a user of one of the multiple user devices in the neighborhood zone for fulfilling the order at the custom fulfillment center;
instructing the user via one of the multiple user devices to deliver the order; and
changing order data associated with the order to signify that the order will be fulfilled by the custom fulfillment center.

21. The system of claim 1, wherein the adjustment factor includes at least one of a seasonality factor and a popularity factor determined by social media data.

22. The system of claim 10, wherein the adjustment factor includes at least one of a seasonality factor and a popularity factor determined by social media data.
